(19) United States
(12) Patent Application Publication
(10) Pub. No.: US 2021/0254368 A1
(43) Pub. Date: Aug. 19, 2021

(54) LOCK FOR A REBATED DOOR

(71) Applicant: BONAITI SERRATURE S.P.A., Calolziocorte (IT)

(72) Inventor: Giovanni ASCHIERI, Torino (IT)

(21) Appl. No.: 16/081,666

(22) PCT Filed: Mar. 1, 2017
(86) PCT No.: PCT/EP2017/054802

§ 371 Date: Aug. 31, 2018

(30) Foreign Application Priority Data
Mar. 2, 2016 (IT) UB2016A001254

(51) Int. Cl. E05B 17/20; E05B 59/00; E05B 47/00; E05B 63/18; E05B 55/06

(52) U.S. Cl. CPC E05B 17/2007; E05B 59/00; E05Y 2900/132; E05B 63/185; E05B 55/06; E05B 47/004

(57) ABSTRACT

A lock for a door of the rebated type, comprising a containing box body, suitable for being housed in a cavity of the rebated door; a latch that is movable between an extracted position and a retracted position in the box body; a driving device movable, by means of a control handle, along an opening direction to move the latch from the extracted position to the retracted position. The driving device is movable, by a key-locking-member, along a locking direction opposite to the opening direction, to reach a disengaged position in which the driving device is not engageable by the control handle, thus preventing the driving of the latch; the driving device comprises a locking arrangement shaped for blocking the latch in the extracted position, preventing forced movement thereof from the outside to the retracted position, when the driving device is in the disengaged position unbound from the control handle. The driving device is defined by, a cursor-element that is geometrically configured to enable to tit into the box body an optional bolt. The cursor-element is provided with a protrusion element for driving and locking the optional bolt.

### CROSS-REFERENCE TO RELATED APPLICATIONS

This application is a § 371 National Stage entry of PCT International Application No. PCT/EP2017/054802 filed Mar. 1, 2017. PCT/EP2017/054802 claims priority to Italian Application No. UB2016A001254 filed Mar. 2, 2016. The entire content of these applications is incorporated herein by reference.

### BACKGROUND OF THE INVENTION

The present invention relates to a lock for a door, in particular for a rebated door.

### STATE OF THE ART

The locks for rebated doors, in particular for interior doors, generally comprise a containing box body intended to be housed in a cavity properly obtained on the rebate of the door, a latch being fitted inside such containing box body, of mechanical or magnetic type, that is movable from an extracted position, with respect to the box body, to a retracted position inside the box body.

In a closed position of the door, with its abutting edge closed to the respective jamb, the latch in the extracted position is received in a corresponding cavity obtained on the jamb, such cavity being delimited by a holding plate. By means of a handle drivable from the outside, in turn engageable with an internal lever mechanism, it is possible to act on the latch to move it from the extracted position to the retracted position thereby making it possible to open the door. In this first type of lock, without bolt, the latch is fitted in correspondence of an almost central zone of the containing box body.

In case a certain safety or privacy are to be guaranteed, the lock only provided with the latch but without the bolt, is equipped with a cylinder-safety key that is operatively connected to the latch by means of proper internal mechanisms, respectively enabling the locking and unlocking of the latch.

In some application contexts, due to specific needs or simply as a response to the tastes or preferences of the users, instead of a lock with only one latch, a second type of lock is proposed, being also equipped with a bolt having key-locking function, in addition to the latch that, however, cannot be blocked when it is in the extracted position. In this second type of lock, the latch and the bolt are totally decoupled, functionally and structurally, from each other. In other words, in addition to the mechanism in charge of driving the latch, an additional mechanism is provided that is dedicated to the coupling between the key-locking cylinder and the bolt. This second type of lock has therefore a considerably higher number of mechanical components and a much higher structural complexity than the first type of lock with the only latch. Furthermore, there is still room for improvement as regards such lock, in particular as regards the effectiveness and the safety level provided by the closure with key-locking blocking function.

It is pointed out that the overall configuration of the second type of lock is, out of necessity, very different from the first type of lock, from a geometrical-structural point of view, because of the presence of two different driving groups (respectively dedicated to the latch and to the bolt) functionally and mechanically decoupled from each other, requiring a different geometric shape and a different positioning of the single components, in particular a different positioning of the latch and of the driving lever with respect to the first type of lock.

In the light of this, in order to fulfil different requirements and different markets, it is clear that it is necessary to produce a determined number of locks both of the first type and of the second type so as to promptly meet the demands for one or the other type of lock. All this implies a certain complexity and effort at production level, due to the manufacturing of a high number of locks units of the two different types that differ both for the number as well as for the geometry of the respective components. It is clear that this also implies expensive assembling operations, and high costs for stocking and managing the whole production process of the two types of locks. The substantially structural, geometrical and size difference of the two above described types of locks, makes it impossible to conceive to modify one of the two types and easily transform it into the other type of lock; in particular, the attempt to modify the first type of lock to make it fitted for housing a bolt is not practicable due to the lack of a large enough volume to receive the driving mechanism in charge of the bolt and due to the need to totally re-design the general layout of the lock and the inner components. Vice versa, in order to transform the second type of lock into the first type of lock it would be necessary to totally re-design the inner mechanical parts so as to define a structural and functional connection between the latch and the driving cylinder.

In the light of what above said, it would be desirable to have a lock, structurally and geometrically configured so as to make possible to optionally fit a bolt, in order to meet both the requests of locks with the only latch, and of locks equipped also with the bold in addition to the latch. This would imply a considerable reduction of costs and at the same time a simplification of the manufacturing, managing, locks stocking processes, thus ensuring to meet at the same time the demands for locks without the bolt and locks with the bolt.

### SCOPES OF THE INVENTION

The scope of the present invention is thus supplying a new and different solution for a lock for rebated door, with mechanical or magnetic latch, that meets the aforementioned needs. In particular it is intended to:
a) supply a constructively simple lock, having a reduced number of mechanical components, thus cheaper to manufacture, and designed to be able to function according to a configuration without bolt or according to a configuration with bolt;
b) supply a lock that is reliable and able to guarantee higher safety levels in the condition of key-locked door;
c) propose a lock that has characteristics enabling an overall improvement in the functioning if compared to the prior art locks.

### BRIEF DESCRIPTION OF THE INVENTION

The present invention therefore intends to reach the aforesaid scopes and overcome the drawbacks of the ordinary locks for rebated doors.

In particular, according to the present invention, it is provided a lock for rebated door, comprising:

a containing box body suitable for being housed in a cavity of said rebated door;

a latch that is movable between an extracted position and a retracted position in said box body;

a driving device movable, by means of a control handle, along an opening direction to move said latch from said extracted position to said retracted position,

said driving device being movable, by a key-locking-member, along a locking direction opposite said opening direction, to reach a disengaged position in which said driving device is not engageable by said control handle, thus preventing the driving of said latch,

said driving device comprises a locking arrangement shaped for locking said latch in said extracted position, preventing a forced movement thereof from the outside towards said retracted position, when said driving device is in said disengaged position from said control handle,

wherein said driving device is defined by a cursor-element that is geometrically configured to enable an optional bolt to be fitted in said box body, said cursor-element being provided with a protrusion element for driving and locking said optional bolt.

### BRIEF DESCRIPTION OF THE DRAWINGS

The invention and some preferred embodiments will be further described here below, referring to the drawings, in which:

FIGS. 1, 2, 3, and 4 show three different operative conditions of a first version of lock according to the invention, without bolt;

FIGS. 5 and 6 are two different views of a cursor-element for driving the lock;

FIGS. 7 and 8 are two exploded views of the lock without bolt and equipped with magnetic latch;

FIGS. 9 and 10 are two exploded views of the lock without bolt and equipped with mechanical latch;

FIGS. 11, 12, 13 show a mechanical latch that can be provided in the different lock versions according to the invention;

FIGS. 14 and 15 show a magnetic latch that can be provided in the lock according to the invention in alternative to the aforesaid mechanical latch;

FIGS. 16, 17, 18, and 19 show three different operative conditions of a second version of lock according to the invention, including also a bolt;

FIGS. 20 and 21 are two different exploded views of the lock version with bolt and in this case magnetic latch;

FIGS. 22 and 23 are two different views of the bolt included in the second lock version;

FIGS. 24 and 25 show an additional lock version having a different geometry of the cursor-element and latch corresponding to an alternative driving configuration of the latch.

### DETAILED DESCRIPTION OF THE INVENTION

It is hereinafter described a lock 1, 101 according to the invention that is suitable to be fitted, in particular, on an internal door of the rebated type, i.e. of the hinged type, though it can in general by applied to rotatable closure elements, of the rebated type.

With reference to Figures from 1 to 8, it is described a first embodiment of lock 1. The lock 1 comprises a containing box body 2, for example made of pressed plate, fitted to be housed in a cavity obtained in the door rebate. The containing box body 2 is composed of two half-shells mutually couplable to define a compartment for the various lock components. The two half-shells together define an upper wall 60, a lower wall 61, two parallel side walls, a back wall 62, and a front wall 63 with an opening 64 to enable the outward projection of a latch 3, here following described.

A front dosing plate 66 is provided, equipped with pass-through opening 67 for the latch 3. Once the box body 2 is fitted inside the door cavity, the front plate 66 is applied on the front wall 63 fixed by means of the same screws used for fixing the lock 1 to the door. Once the closing front plate 66 is fitted, the pass-through opening 67 thereof is arranged in correspondence of the opening 64 provided on the front wall 63, to enable the exit of the latch 3.

The lock 1 comprises a latch 3 (magnetic) or 3′ (mechanical) movable, along an entrance direction D_{I}, between an extracted position E, that is outwardly protruding from the box body 2, and a retracted position R in which the latch 3 is positioned inside the box body 2.

The latch 3 or 3′ is fitted to engage with a holding plate that is mounted on the door jamb in correspondence of the engaging cavities for latch and bolt.

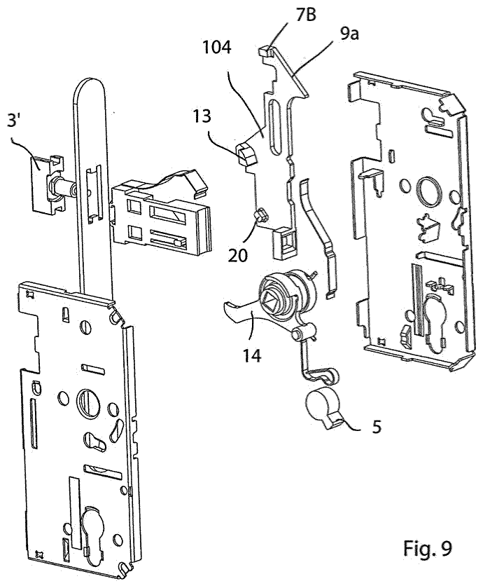

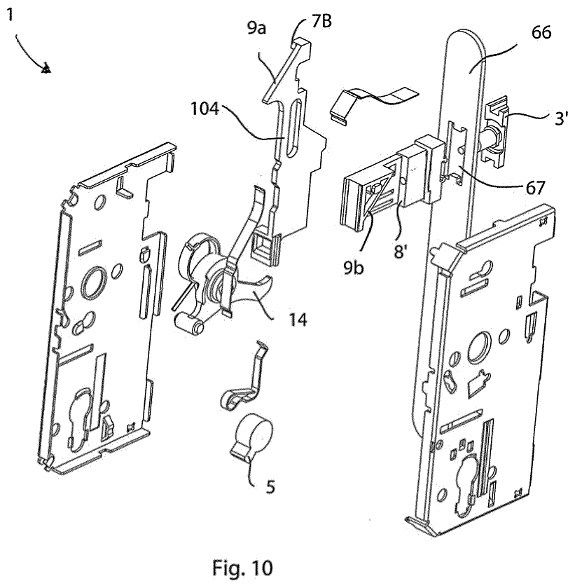

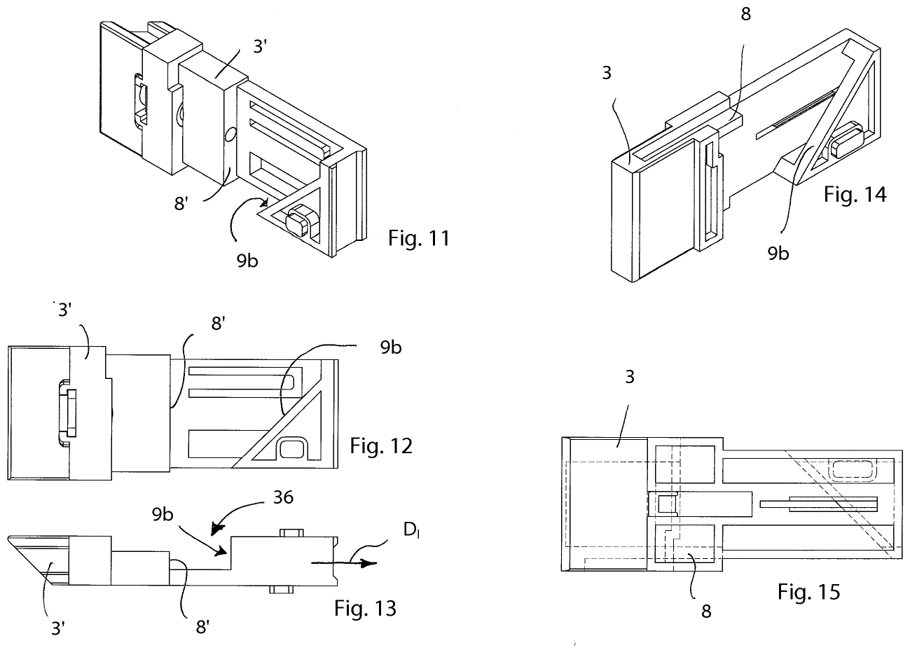

Figures from 1 to 8, to which reference is made for the following description, relate to a first lock version 1, without bolt and provided with magnetic latch 3. It goes without saying that the version with mechanical latch 3′ (shown in the FIGS. 9 and 10) is functionally and structurally similar to the herein described one, apart from differences that will be outlined later on. In particular, FIGS. 11, 12, 13 show more in detail the mechanical latch 3′, alternative to the magnetic latch 3 that is instead shown in the following FIGS. 14 and 15.

The lock 1 comprises a driving device 4 movable along an opening direction D_{A} to move the latch 3 from the extracted position E to the retracted position R. Driving device 4 is movable along the aforesaid opening direction D_{A} by means of a rotatable lever organ 14 that is in turn drivable by an external control handle.

In particular, the opening direction D_{A} is transverse with respect to the entrance direction D_{I} along which the latch 3 is movable.

In order to move the latch 3 from the extracted position E to the retracted position R, the lock 1 is provided with a motion transferring arrangement, hereinafter better described, that transform a movement of the driving device 4 along the opening direction D_{A} into a movement of the latch 3 towards the entrance direction D_{I}.

Furthermore, the driving device 4 is movable, through a key-locking-member 5, along a locking direction D_{B} opposite the aforesaid opening direction D_{A}, to reach a disengaged position P_{D} in which the driving device 4 is not engageable by the control handle 14 coupled to the external control handle. Thereby, the driving of latch 3 is avoided. Such disengaged position P_{D} can be viewed in FIG. 3. Substantially, when the driving device 4 are in the disengaged position P_{D}, the possible driving of the external handle has no effect on them. In other words, the handle is in “idle” configuration and does not at all affect the position of the latch 3. Driving device 4 is elastically urged downwards by a flexion spring 46 laying on a fixed shelf-shaped winglet 47 of the containing, body. When the driving de-vice 4 is lifted along the opening direction, a top portion of them finds a resistance of the flexion spring 46 that makes the driving device 4 return to a rest position as soon as the handle is released.

The key-locking member 5 comprises in particular a cylinder-key provided with a bit element, that can be driven rotatably by inserting a specific key. In another version, the locking-member 5 is defined, instead of a cylinder-key, by a specific key provided with stem and a duly shaped driving portion.

In particular, driving device is defined by a slider or cursor-element 4 that extends longitudinally so as to mutually connect the key-locking-member 5 and the bolt 3. As it will be shown also from the description later on, the cursor-element 4 is geometrically configured to enable fitting, if required, an optional bolt 6 into the containing box body 2. In order to be suitable for this event, the cursor-element 4 is already provided with a protrusion element 20, in particular a pin protrusion 20, arranged to engage with the possible bolt 6 so as to drive it and block it in the protruding operative position P_{O}. In particular the pin protrusion 20 is adapted to engage with a driving groove 30 obtained on the bolt 6 (eventually provided in the lock), as described in detail hereinafter.

Substantially, one single driving mechanical element, that is the cursor-element 4 provides to couple, mechanically and operatively, not only the latch to the key-locking-member 5 but also to the bolt 6 in case the lock is required to be provided with the latter.

The cursor element 4 comprises a pushing-portion 9a shaped to move the latch 3 to the retracted position R when the cursor-element 4 advances along the opening direction D_{A}.

On the cursor-element 4 an engaging lug 13 is obtained, arranged in an intermediate zone I thereof, with respect to the longitudinal dimension, and arranged to move in a region defined between the latch 3 and an area Y near which the key-locking element 5 is housed. The engagement lug 13 is configured to be able to couple with a lever 14 drivable by the control handle in order to move the cursor-element 4 along the opening direction D_{A}.

The cursor-element 4 comprises an abutting zone 15, placed at an end M opposite to the pushing-portion 9a, and shaped for interacting with the member 5 for key-locking the lock 1.

The driving and locking pin protrusion 20 is obtained between the aforesaid intermediate zone I and the end M, and the cursor-element 4 is geometrically shaped in such a way that it enables the fitting, in the box body 2, of the optional bolt 6, in a housing space H comprised between the aforesaid engaging lug 13 and the aforesaid area Y.

As it can be clearly seen in the drawings, we have a lock layout wherein the lever 14 is fitted between the latch 3 and the key-locking-member 5, the cursor-element 4 has a length (according to a vertical direction in the figures) that is as sufficient as to be able to connect mechanically the latch 3, the key-locking-member 5 and the optional bolt 6 reciprocally, and has a geometrical conformation that enables to house such bolt 6 between the key-locking-member 5 and the lever 14.

The aforesaid motion transferring arrangement (9a; 9b; 10a, 10b, 11) that comprises part of the cursor-element 4 and part of the latch 3 (or 3′, 3″) is now described.

Specifically, the motion transferring arrangement comprises a pushing portion 9a provided on an upper zone of the cursor-element 4 and a follower portion 9B obtained on the latch 3; (3′). The pushing-portion 9a is shaped to come in contact with the follower-portion 9b in order to move the latch 3 or (3′) to the retracted position R when the cursor-element 4 advances along the opening direction D_{A}. The pushing-portion 9a and the follower portion 9h are shaped for sliding on one another in mutual contact.

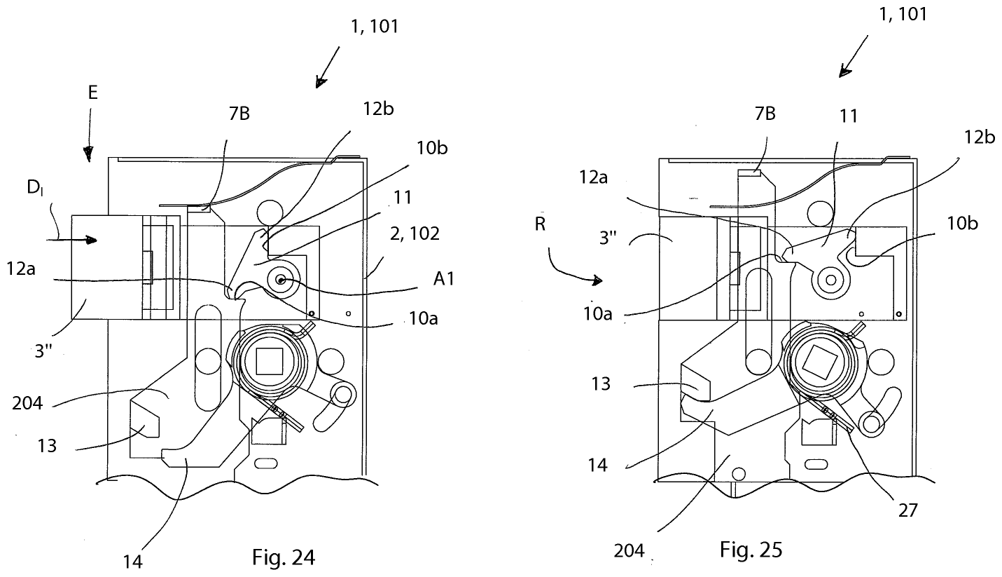

In particular, in all the lock versions shown in the enclosed drawings, apart from the version of FIGS. 24 and 25 (hereinafter described), the pushing-portion of the cursor-element 4 and the follower-portion of the latch 3 (or 3′) comprise respectively a tilted surface 9a, and an additional tilted surface 9b that are arranged transversally with respect to the entrance direction D_{I} and to the opening direction D_{A}. In other words, motion transferring arrangement is configured, in the described version, for establishing between the cursor-element 4 and the latch 3 a relative sliding according to a plane laying inclined with respect to the opening direction D_{A} and to the entrance direction D_{I}.

According to a further embodiment (not shown) applicable both to the lock version 1 without bolt 6 and lock version 101 with bolt 6, it is possible to envisage, as a replacement of just one of the two tilted surfaces 9a and 9b, a small-wheel portion, or other similar solution, adapted to slide on the remaining tilted surface.

Referring to the description of lock 1, the engaging lug 13 of the cursor-element 4 is adapted to couple to a nose-shaped portion of the lever member 14, receiving a push action by the latter from the bottom to be pushed upwards so as to retract the latch 3 (or 3′) in the containing box body 2. The lever member 14 is elastically urged towards a rest position by a proper torsion spring 27.

The abutting zone 15 comprises a first abutting portion 16 that is suitable for receiving from the key-locking-cylinder 5 a push-action to move the cursor-element in the locking direction D_{B}, and, in particular downwards.

The abutting zone 15 comprises a second abutting portion 17 that is suitable for receiving from. the key-locking cylinder 5 a further push-action to move the cursor-element 4 in the opening direction D_{A}, in particular upwards. The first abutting portion 16 and the second abutting portion 17 are protruding and project orthogonally with respect to the plane defined by the cursor-element 4, in other words parallel to the rotation axis of the key-locking cylinder 5.

The cursor-element 4 comprises a locking arrangement 7A shaped for locking the latch 3 in the extracted position E, preventing a forced movement thereof from the outside to the retracted position R, when the cursor-element 4 is in the disengaged position P_{D} unbound from the lever member 14. In other words, the locking arrangement 7A acts to prevent the latch from returning back, by means of an undesired external action, when the lock 1 is in the key-locked configuration. Therefore, in the key-locked configuration, not only a possible rotation of the handle in the “idle” status does not have any effect on the latch 3, but any other forced movement of the latch is also avoided.

In the lock version 1 with magnetic latch 3, the locking arrangement is defined by a locking ridge 7A, shaped to support a protruding wall $ of the latch 3. In particular, the locking ridge comprises a locking winglet 7A projecting orthogonally at an edge of the cursor-element 4 facing the front wall 63 of the box body 2. In the key-locked condition with the cursor-element 4 in lowered position, the movement of the latch 3 from the extracted position E to the retracted position R is avoided.

Moreover, the protruding wall 8 arranged on the magnetic latch 3 has an additional function. In the open door condition, the magnetic latch 3 is in a non-operative condition, that is, it is freely housed inside the containing box body 2, In such a condition, the cursor-element 4, acting by means of the key-locking cylinder 5, is unable to go down along the locking direction D_{B}; such an effect is reached thanks to the protruding wall 8 which, in the retracted position R of the latch 3, is arranged immediately under the locking winglet 7A, hindering the downward movement. The advantage of such configuration is to avoid a fake key-locking manoeuvre. In other words, the cursor-element 4 is prevented from reaching the disengaged position Pd, when the door is not yet actually approached to the jamb in a closed position. In fact, if the disengaged position P_{D} could be reached in a condition wherein the latch 3 is in retracted position and the open door is not yet closed to the jamb, and assuming the key is lost soon after having driven the cursor-element 4 towards the disengaged position P_{D}, the following would occur: once having approached the door to the jamb, the magnetic latch 3 would be magnetically attracted for engaging in the respective cavity of the jamb, and, without availability of the lost key, it would not be possible to open again the door because the handle is in the “idle” position.

Thanks to the protruding wall 8 (of the magnetic latch 3) interacting with the locking ridge 7A (of the cursor-element 4) such undesired circumstance is avoided.

If compared to the above described version with magnetic latch, the lock 1 with mechanical latch 3′ has some little differences as far as locking arrangement is concerned. In this case, the cursor-element as well, here indicated by 104, has little differences if compared to the above described cursor-element 4 as regards the magnetic latch 3.

Substantially, locking arrangement comprises, instead of the locking winglet 7A (absent in this case), a different locking ridge, that is a turrett portion 7B obtained on top of the cursor-element 104, also having the function to interact with, the flexion spring 46 downwardly urging the cursor-element 104 (and also the cursor-element 4 previously described). The turrett portion 7/b is shaped to support, and block, an additional protruding wall 8′ positioned on the mechanical latch 3′.

When the cursor-element 104 is in the lowered position, that is, in the key-locked condition of lock 1, the turrett portion 7B is below the shelf-shaped winglet 47 on which the flexion spring 46 stands. In particular, the turrett portion 713, being housed in a recess zone 36 of the latch 3′ (FIG. 13), is in correspondence of the protruding wall 8″ which is hindered in the retracted movement towards the internal containing box body 22 along the entrance direction D_{I}.

It is now synthetically described the lock 1 functioning.

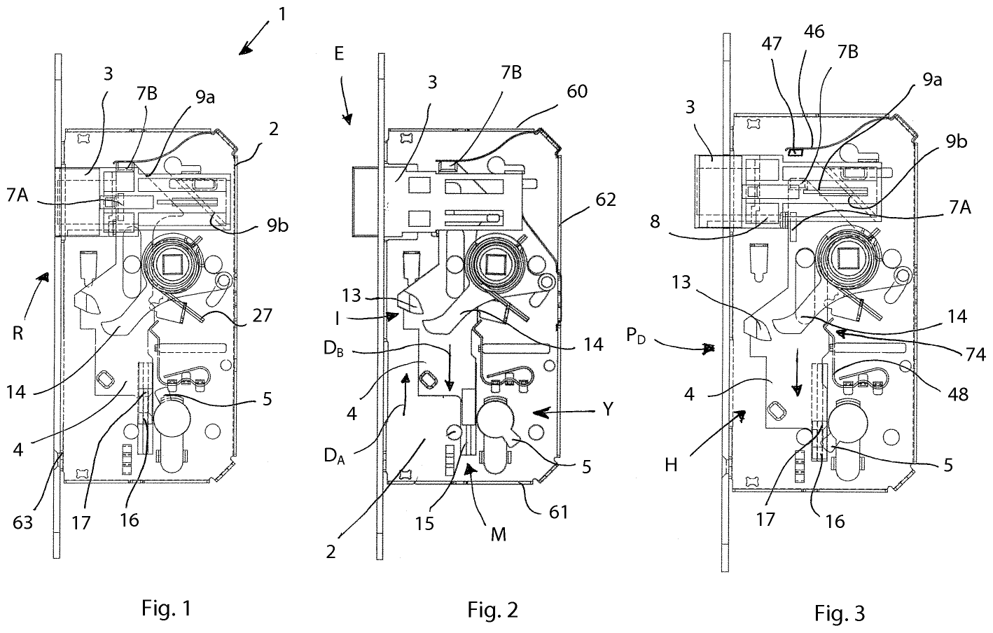

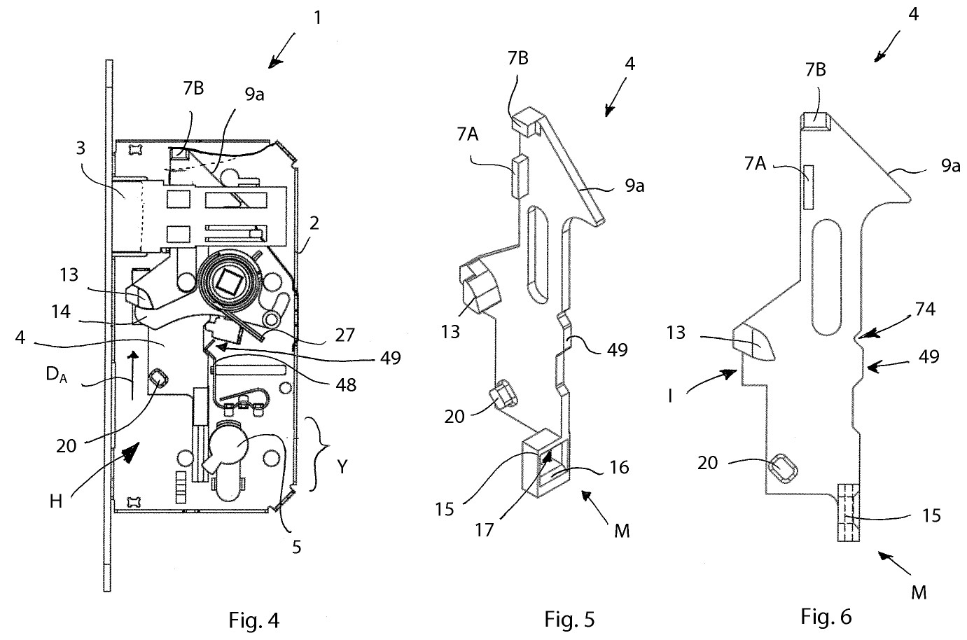

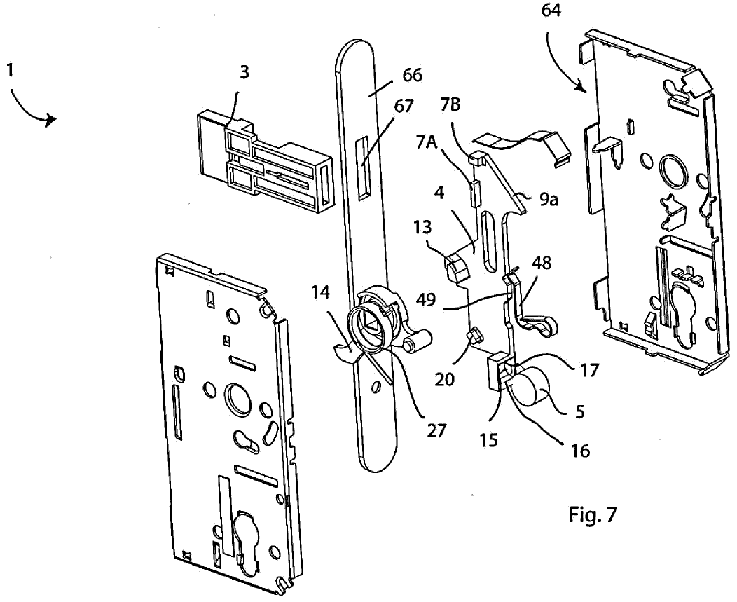

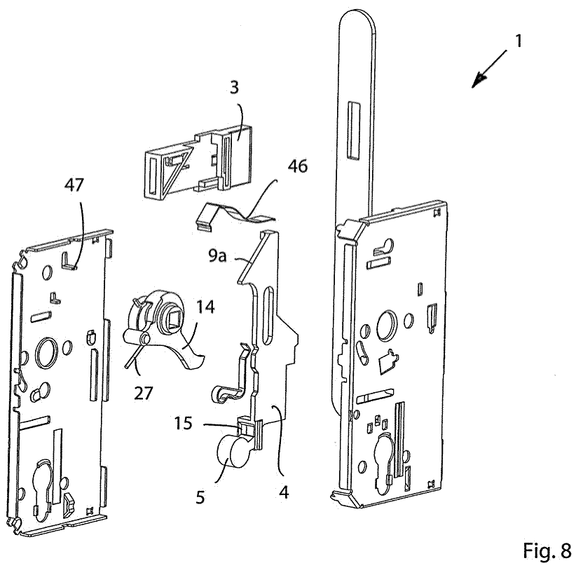

When the door is open, the lock 1 is in the condition shown in the FIG. 1, that is the magnetic latch 3 is in the retracted position R, thus freely retracted inside the containing box body 2. (Obviously, in the case of lock 1 with mechanical latch 3′, the latter, when it is in the rest position, protrudes from the containing box body 2, urged by a suitable internal spring). In this condition, the potential driving of the cylinder 5 for key-locking the lock 1 is prevented by the protruding wall 8 of the magnetic latch 3 that hinders the movement of the locking ridge 7A in the locking direction D_{B}.

Once the door approaches to the jamb, the magnetic latch 3 is magnetically attracted, for example as a result of a magnetic element associated to the jamb, inside the respective cavity provided on the jamb thereof. Thereby, the protruding wall 8 disengages from the locking ridge 7A which is free to move downwardly. By initiating the rotation of the cylinder 5—counter-clockwise with respect to Figures from 1 to 3,—the bit element of the cylinder 5 comes into contact with the first abutting portion dragging the cursor-element 4 downwardly, along the locking direction D_{B}, and reaching the disengaged portion P_{D}, in which the engaging lug 13 is disengaged from the lever 14 coupled to the external handle.

In this configuration the cursor-element 4 is lowered in the locking position and the locking ridge 7A, that is the locking winglet 7A, is in such a position as to block the protruding wall 8. In this'key-locked condition of lock 1, any attempt to push from outside the latch 3 (or 3′) inwards is prevented.

The opening procedure occurs in a different way. Therefore, rotating the cylinder 5 clockwise this time, the second abutting portion 17 is pushed upwards and the cursor-element 4 reaches again the position wherein the engaging lug 13 is engageable by the lever 14.

Further rotating the member 5, the bit element pushes, acting below the abutting zone 15, the cursor-element 4 further upwards, therefore beyond the normal rest position, contrasting the first flexion spring 46; in this operative condition, the cursor-element 4 serves also the scope that the handle normally has, in other words it is able to retract the latch into the containing box body 2 and enable the opening of the door,

A second flexion spring 48 is provided, which, interacting with a cam profile 49 of the cursor-element 4, establishes a rest position for the cursor-element 4 and provides a desired tactile feedback to the user during the driving of the cylinder 5. Such a tactile feedback indicates that a complete opening or closing manoeuvre of the lock 1 has been performed, providing to the user the feeling of having performed in a complete and correct way the various door locking and unlocking operations.

The lower stop position for the cursor-element 4 is determined by the flexion spring 48 that engages in a recess 74 obtained on the edge of the cursor-element 4, as shown in FIGS. 3 and 6.

In Figures from 16 to 23 a further lock version 101 is shown, differing from the previously described lock 1 in that it is provided with bolt 6 too. What has been already described for the lock I without bolt, both in structural and in functional terms, also applies to the lock version 101 provided with bolt 6 and many parts that are in common to the first version will be omitted for ease of explanation.

The bolt 6 for key-locking the door can be driven through the said key-locking member 5 and is movable from a non-operative position P_{N}, in which it is retracted in the box body 102, to an operative position P_{O} in which it protrudes outside from the box body 102.

The bolt 6 comprises a sliding-guide winglet 70 sliding in a slot 71 obtained on the containing box body 102.

In this case as well, the key-locking member 5 may comprise a cylinder-key provided with a bit element, that can be driven rotatably by inserting a specific key, or it can comprise instead of a cylinder-key, a specific key provided with stern and a duly shaped driving portion.

For the lock 101, a front closing plate 166 is provided, having, in addition to a pass-through opening 67 for the latch 3, an additional pass-through, opening 68, to be positioned in correspondence of the opening 65—obtained on the box body 102—that enables the exit movement of the bolt 6.

The bolt 6, shown more in detail in FIGS. 22 and 23, is provided with a driving groove 30 adapted to engage with the pin protrusion 20 (already previously described) provided on the cursor-element 4 (or 104).

The driving groove 30 comprises a tilted portion so that a movement of the cursor-element 4 in the locking direction D_{B} causes a projection of the bolt 6 to the outside by a length Q. Vice versa, to a movement of the cursor-element 4 in the opening direction D_{A} corresponds a retracting movement of the bolt 6 to the inside of the box body 102, An additional upper portion 35 of the groove 30, extending vertically, disengages the bolt 6 from the pin protrusion 20 enabling it to move upwards in case it is requested to retract the latch 3 (or 3′) into the box body 102, acting through the external handle or through the key-locking member 5.

The groove 30 also comprises a locking portion 37, extending perpendicularly with respect to the movement direction of the bolt 6. In particular, the locking portion 37 extends vertically. The pin protrusion 20, when positioned in the aforesaid locking portion 37, locks the bolt 6 in the operative extracted position P₀, preventing forced movements from the outside.

The pushing of the key-locking member 5 on the first abutting portion 16 causes a downward movement of the cursor-element 4—in the locking direction D_{B}—which in turn determines the movement of the bolt 6 from the box body 102 by a quantity Q for reaching the operative position Po shown in FIG. 18. This is made possible by the lowering of the pin protrusion 20—along the locking direction D_{B}—that forces the driving groove 30 to “follow” it, thus determining the bolt 6 movement towards the operative position P_{O}. In the maximum prominent position, the bolt 6 is protruding, with respect to the containing box body 102, by a quantity Q that can be, in particular but without limitation, equal to 11.5 mm.

What already described for the locking arrangement 7A (in the case of magnetic latch 3) or 7B (in the case of mechanical latch 3′) applies likewise to this version of lock 101 provided with bolt. Beside the locking arrangement 7A or 7B that acts on the latch, an additional locking element is to be highlighted represented by the pin protrusion 20 that acts for driving and also for locking the bolt 6 in the prominent operative position P_{O} when the pin protrusion 20 is positioned in the locking portion 37 of the groove 30.

In the key-locked condition with the cursor-element 4 in lowered, position wherein the bolt 6 too is in the prominent position towards the outside, both a movement of the latch 3 from the extracted position E to the retracted position R, and a bolt 6 movement are prevented. Therefore, in such a condition, there are as many as two zones that are actually locked in extracted position, ensuring the totally safe closing of the door, unlike what happens with the prior art systems provided with latch and bolt in which only the bolt is eventually locked. Thus, this lock results to be considerably safer as regards break-in attempts.

Moreover, the protruding wall 8 arranged on the magnetic latch 3 has an additional function. In the door open condition, the magnetic latch 3 is in a non-operative condition, that is, it is freely housed inside the containing box body 2. in such condition, the cursor-element 4, acting by means of the key-locking-cylinder 5, is unable to go down along the locking direction D_{B}; such an effect is reached thanks to the protruding wall 8 which, in the retracted position R of the latch 3, is arranged immediately under the locking winglet 7A, hindering the downward movement thereof. The advantageous effect of such configuration is preventing the movement of the bolt 6 out of box body 2 when the door is not actually closed to the jamb, thus avoiding to damage the latter in case the door is pushed against the jamb with the bolt in prominent position.

The protruding wall 8 enables the movement of the cursor-element 4 along the locking direction D_{B} only when the magnetic latch 3, being magnetically attracted into the extracted position E, is received correctly in the respective cavity of the jamb.

Since the lock 101 is shaped, structurally and functionally, as the lock 1, its functioning is similar to the previous description of the lock version without bolt 6. The only difference is the presence of the bolt 6 that is driven by the same element that is shared both from the member 5 and from the latch 3 (3′), that is to say from the cursor-element 4.

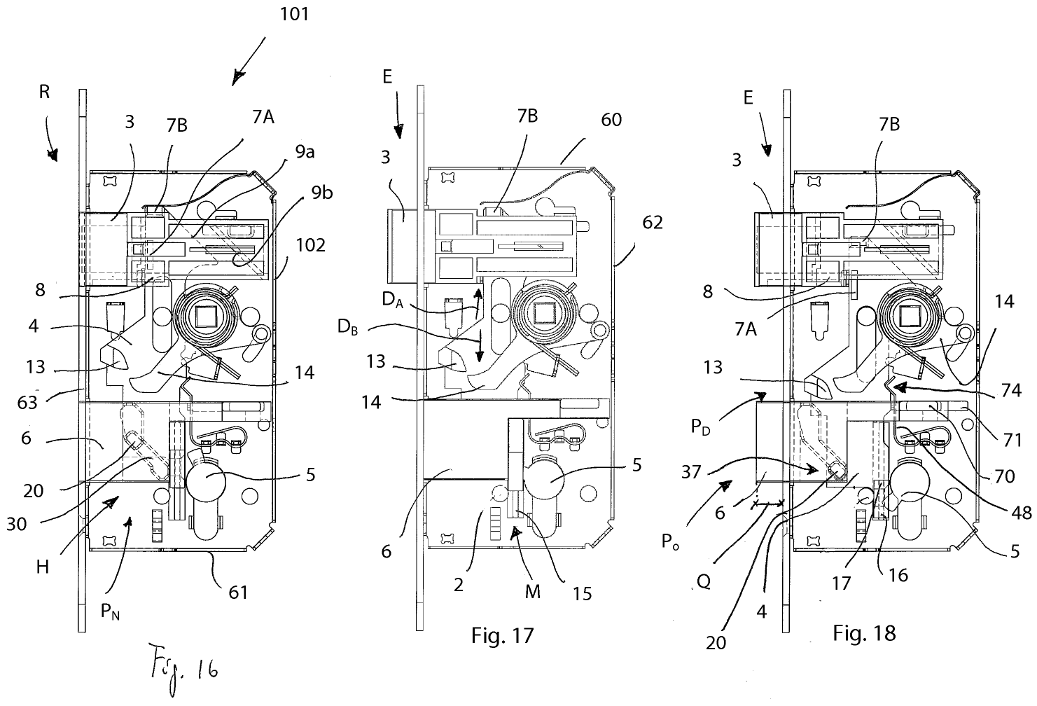

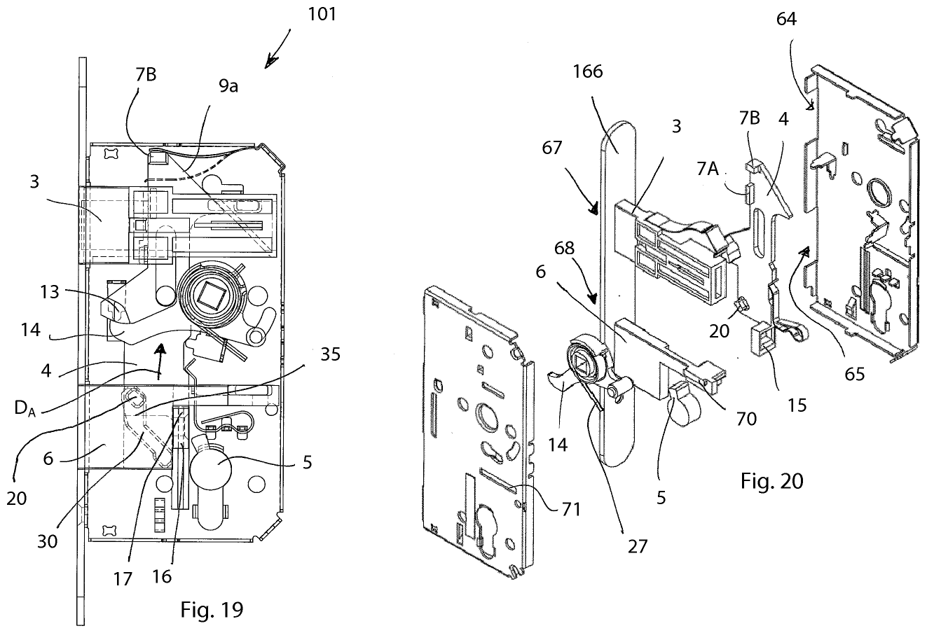

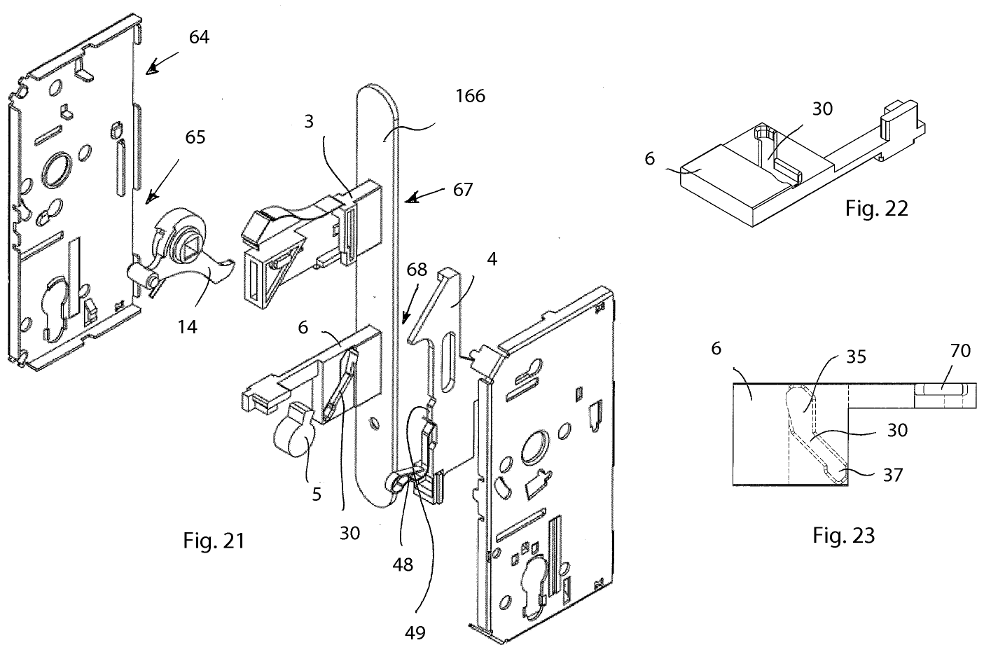

FIGS. 16, 17, 18 show different operative conditions, a first condition with magnetic latch 3 and bolt 6 retracted in the box body 102, a second condition with extracted latch 3 and bolt 6 in non-operative position P_{N}, and a third condition with the prominent bolt 6 too in an operative position P_{O}, respectively. In this third condition, the cursor-element 4 is in the disengaged position P_{D}, therefore the handle is in the “idle” position, and both the latch 3 and the bolt 6 are respectively blocked by the locking winglet 7A opposing the protruding wail 8, and by the pin protrusion 20 engaged in the vertical locking portion 37 of the groove 30 of the bolt 6.

The opening procedure occurs in an opposite way, as described in the previous versions.

FIGS. 24 and 25 show an additional possible configuration of the motion transferring arrangement, alternative to the previously described versions both for the lock 1 and for the lock 101. Such configuration envisages a partial modification of the cursor-element, hereby indicated by 204, and of the latch hereby indicated by 3″, which in turn can be magnetic or mechanical.

According to such configuration, the motion transferring arrangement comprises a pushing portion 10a obtained on the cursor-element 204, a follower portion 10b obtained on the latch 3″, and a rotatable lever member 11 interposed between the aforesaid portions 10a and 10b.

In particular, the pushing-portion 10a and the follower-portion 10b comprise respective surfaces arranged lying orthogonally one another. In particular, the pushing portion 10a comprises a surface arranged substantially orthogonally with respect to the opening direction D_{A} along which the cursor-element 204 is movable, while the follower-portion 10b comprises a surface substantially arranged orthogonally with respect to the entrance direction D_{I} along which the latch 3″ is movable. The lever member 11 is rotatable around an axis A1 orthogonal to the plane defined by the aforesaid opening and entrance directions D_{A}, D_{I} and comprises appendages 12a and 12b suitable to engage respectively with the pushing portion 10a and with the follower portion 10b. Appendage 12a is pushed by the cursor-element 204 while appendage 12b transfers the pushing on the follower-portion 10b: thereby a movement of the cursor-element 204 along the opening direction D_{A} is transformed into a movement of the latch 3″ along the entrance direction D_{I}.

It is clear, from what has been above described and shown in the drawings, that the lock 1, 101 according to the invention enables to reach the declared scopes. In particular, a new solution for lock for debated door is provided, with mechanical or magnetic latch, constructively very simple, having a reduced number of mechanical components, thus cheaper to manufacture, and designed to be easily assembled to function with or without bolt. This is made possible by the peculiar arrangement of the inner mechanical parts and by the advantageous configuration of the cursor-element 4, 104, 204 which serves as single functional connecting element between the latch 3 (3′; 3″), bolt 6 and closing member 5, unlike the prior art locks wherein two different parts are defined (respectively related to the latch and the bolt) totally uncoupled from one another both from a functional and structural point of view, marked by a considerable structural complexity.

Due to the “modular” aspect of the lock according to the invention, it is possible to simplify and unify the manufacturing, managing and assembling process, since the “basic” components to be produced are the same both for the lock 101 intended to receive the bolt 6, and for the lock 1 intended to operate without bolt 6. A reduced number of components implies a reduction of manufacturing costs, a simplification of the manufacturing processes, an easier managing of the production lines, a reduction of stocks, though ensuring, at the same time, a wide range of locks suitable to meet the various needs related to the different markets worldwide.

Furthermore, the lock according to the invention is able to guarantee higher safety standards in the key-locked condition of the door, and also has characteristics that enable to reach an overall improved :functioning with respect to the prior art locks.

What has been said and shown in the enclosed drawings, was an exemplary description provided for illustrative purposes of the innovative characteristics of the lock for rebated door according to several embodiments.

Modifications to the lock or to any of its part shall occur without departing from the claims.

In practise, the materials, as long as they are compatible with the specific use and with the respective single components they are addressed to, can be duly chosen according to the requested requirements and according to the state of the art availability.

It is also possible to configure and size the lock and adopt material according to the needs, and variants and/or additions to what above described and shown in the drawings are possible.

1-15. (canceled)

16. Lock for a door of the rebated type, comprising
a containing box body, suitable for being housed in a cavity of said rebated door;
a latch that is movable between an extracted position and a retracted position in said box body;
a driving device movable, by means of a control handle, along an opening direction to move said latch from said extracted position to said retracted position,
said driving device being movable, by a key-locking-member, along a locking direction opposite said opening direction, to reach a disengaged position in which said driving device are not engageable by said control handle, thus preventing the driving of said latch,
said driving device comprises a locking arrangement shaped for locking said latch in said extracted position, preventing forced movement thereof from the outside to said retracted position, when said driving device is in said disengaged position from said control handle,
wherein said driving device is defined by a cursor-element that is geometrically configured to enable an optional bolt to be fitted in said box body, said cursor-element being provided with a protrusion element for driving and locking said optional bolt.

17. Lock according to claim 16, wherein said cursor-element comprises:
a pushing-portion shaped to move said latch to said retracted position when said cursor-element advances along said opening direction,
an engaging lug, obtained, longitudinally, in an intermediate zone of said cursor-element and movable in a region comprised between said latch and an area housing said key-locking-member, said engaging lug being suitable for coupling with a lever that is drivable by said control handle to move said. cursor-element along said opening direction,
an abutting zone, placed at an end opposite said pushing-portion, shaped for interacting with said member for key-locking said lock,
wherein said driving and locking protrusion element is positioned between said intermediate zone and said end, and said cursor-element is shaped to enable said optional bolt to be fitted in said box body in a housing volume comprised between said engaging lug and said area.

18. Lock according to claim 17, wherein said lever is fitted between said latch and said key-locking-member and wherein said cursor-element extends longitudinally with a dimension in length that is such as to be able to connect mechanically said latch to said key-locking-member and to said optional bolt, said cursor-element being adapted to enable said bolt to be housed between said key-locking-member and said lever.

19. Lock according to claim 16, and further comprising said bolt, said bolt being drivable by said key-locking-member and being movable from a non-operative position, in which it is retracted into said box body, to an operative position protruding outside said box body.

20. Lock according to claim 19, wherein said bolt is provided with a driving groove and said driving and locking protrusion element comprises a pin protrusion protruding from said cursor-element to engage in said groove, said groove having a tilted portion in such a manner that a movement of said cursor-element in said locking direction causes a projection of said bolt to the outside by a length, and vice versa, to a movement of said cursor-element in said opening direction a retracting movement of said bolt to the inside of said box body corresponds.

21. Lock according to claim 20, wherein said groove comprises a blocking portion, extending orthogonally to the movement direction of said bolt, said pin protrusion, in the position of engagement with said blocking portion, acting as a blocking element for blocking said bolt in said operational position, preventing forced movements thereof from the outside.

22. Lock according to claim 16, wherein said locking element comprises a locking ridge shaped for supportingly receiving a protruding wall of said latch, preventing a movement of said latch from said extracted position to said retracted position when said driving device is in said disengaged position, and said bolt is in a position protruding from said box body.

23. Lock according to claim 22, wherein said, latch is of magnetic type and is freely arranged in said retracted position when said door is open, said protruding wall being positioned to hinder, in said retracted position, said locking ridge, to prevent said driving device from moving in said locking direction, said protruding wall enabling said driving device to move in said locking direction when said magnetic latch, in said extracted position, is received in a respective cavity of a doorjamb.

24. Lock according to claim 16, wherein said latch, of magnetic type or of mechanical type, is movable from said extracted position to said retracted position along an entrance direction that is orthogonal to said opening direction, a motion transferring arrangement being provided that is configured to impose on said latch a movement along said entrance direction correspondingly to a movement of said driving device along said opening direction.

25. Lock according to claim 24, wherein said cursor-element comprises:
a pushing-portion shaped to move said latch to said retracted position when said cursor-element advances along said opening direction,
an engaging lug, obtained, longitudinally, in an intermediate zone of said cursor-element and movable in a region comprised between said latch and an area housing said key-locking-member, said engaging lug being suitable for coupling with a lever that is drivable by said control handle to move said cursor-element along said opening direction,
an abutting zone, placed at an end opposite said pushing-portion, shaped for interacting with said member for key-locking said lock,
wherein said driving and locking protrusion element is positioned between said intermediate zone and said end, and said cursor-element is shaped to enable said optional bolt to be fitted in said box body in a housing volume comprised between said engaging lug and said area, and wherein said motion transferring arrangement comprises said pushing-portion, provided on said cursor-element, and a follower-portion obtained on said latch.

26. Lock according to claim 25, wherein said pushing-portion and said follower-portion are shaped for coming into reciprocal contact to slide on one another.

27. Lock according to claim 26, wherein said pushing-portion and/or said follower-portion comprise a tilted surface arranged transversely to said entrance direction and to said opening direction.

28. Lock according to claim 25, wherein said motion transferring arrangement further comprises a rotatable lever member provided with appendages suitable for engaging respectively said pushing-portion and said follower-portion, said lever member being rotatable around an axis orthogonal to the plane defined by said opening direction and entrance direction to transfer a movement of said cursor-element along said opening direction to said latch along said entrance direction.

29. Lock according to claim 17, wherein said abutting zone of said cursor-element comprises:
a first abutting portion that is suitable for receiving from said key-locking-member a push-action to move said cursor-element in said locking direction, and,
a second abutting portion that is suitable for receiving from said key-locking-member a further push-action to move said cursor-element in said opening direction.

30. Lock according to claim 16, wherein said key-locking member comprises a bit element included in a cylinder for a lock controllable by a key, or comprises a key element provided with a cam portion for acting on said driving device and on said bolt.
